(19) United States
(12) Patent Application Publication
(10) Pub. No.: US 2011/0257135 A1
(43) Pub. Date: Oct. 20, 2011

(54) TOPICAL PESTICIDE FORMULATION

(76) Inventor: Warren Roy Agnew, Warkworth (NZ)

(21) Appl. No.: 13/140,703

(22) PCT Filed: Dec. 19, 2008
(86) PCT No.: PCT/NZ08/00339

§ 371 Date: Jun. 17, 2011

(51) Int. Cl. A01N 31/00; A01P 15/00; A01P 11/00

(52) U.S. Cl. 514/167

(57) ABSTRACT

Described are formulations and methods for animal pest control. A formulation for topical administration to animal pests includes a solution including an effective amount of cholecalciferol (also known as Vitamin D3) and at least one dermal penetrant or carrier, such that a lethal dose of the cholecalciferol can be delivered transdermally to an animal pest in solution, thereby being absorbed into the animal's bloodstream and subsequently causing the death of the animal. The formulation and method is effective at killing pests such as mice, rats, stoats, weasels, ferrets, rabbits, hedgehogs and possums.

### FIELD OF INVENTION

The invention generally relates to formulations and methods for animal pest control.

### BACKGROUND OF INVENTION

Pest control is a major problem in most countries of the world, and particularly in New Zealand due to the wide variety of species, particularly mammals, which were introduced to New Zealand by the early European settlers. Pests such as rabbits, rats, mice, possums, stoats, ferrets and weasels have had a significant effect on native flora and fauna. Rodents (rats and mice) and mustelids (ferrets, stoats and weasels) are significant conservation pests because they are predators and competitors of native fauna. Rats eat bird eggs, chicks and invertebrates as well as fruits and seeds. Predation by rodents is a significant threat to endangered and iconic bird species such as the kokako. Scientific studies have identified stoats as a major predator of bird eggs and chicks, including kiwi. Stoats have large territories and can cover 8 km in a night as they seek food. Without predator control, only about 5% of kiwi chicks survive in the wild. Feral cats, goats, deer and wallabies are other examples of pest species. Due to the damage caused to native flora and fauna, it is necessary to implement measures to control these pests.

There has been steady development and refinement of pest control technologies and approaches in New Zealand over the past 50 years. These have been driven by the need for more specific targeting of pests, more humane methods of killing the pests, greater operational efficiencies and effectiveness. The desired outcomes have not focused on the number of pests killed, but on saving threatened species and ecosystems as well as improving the productivity and health of the primary production sectors, notably agriculture.

Methods of pest control which have been employed in New Zealand and other countries to date include traps and poisons.

Traps have been used to catch possums for many decades. They have also been used to trap stoats, however they have been found to be inefficient. For example, the Department of Conservation in New Zealand is responsible for the setting of some 60,000 stoat traps each and every day of the year. These traps are generally metal and spring loaded, and because of their danger to the ground feeding kiwi, are placed in a box with a restricted opening designed to keep kiwi away from the traps. However the kill rate from these traps only averages one stoat for every 300 trap nights. During this time the traps have to be checked, re-baited or cleared. Hence a huge amount of expense and effort is being channelled into killing a very cunning and wary animal.

There are six poisons currently registered in New Zealand for possum control: 1080 (sodium fluoroacetate), cyanide, phosphorus, pindone, brodifacoum, and cholecalciferol (Vitamin D3). Some are also registered for the control of other pests. All of these poisons are available in bait form such as pellets, pastes, gels, coated baits, and cereal baits intended for oral ingestion by the target species. Although most of these poisons are effective at killing pests, they have disadvantages. Phosphorus, 1080 and brodifacoum have high secondary poisoning risks to dogs, birds and other animals due to the movement down the food chain and their persistence in the environment. Phosphorus, brodifacoum and pindone are considered to be inhumane methods of pest control generally because it takes a long amount of time before death occurs (for example, a few weeks). Although cyanide is an effective poison and has low environmental persistence and secondary poisoning risk, it is hazardous in paste form and is toxic to humans, requiring a licence to store, handle and use it.

Cholecalciferol, also known as Vitamin D3, is a relatively new poison, introduced in New Zealand in 1995. It was introduced initially for possum control, and is also a rodenticide. It is commercially available in bait form only, both as a cereal based bait for killing possums (CAMPAIGN containing 0.8% cholecalciferol), and a paste bait for possums and rats and mice (FERACOL, 0.8% for possums and 0.08% for rats and mice).

In order to gain biological and toxicological activity, cholecalciferol must undergo metabolic conversion to 25-hydroxycholecalciferol. At toxic doses, this active metabolite mobilises calcium stores from the bones into the bloodstream, and decreases calcium excretion by the kidneys. The net result is dangerously high concentrations of blood calcium (hypercalcaemia) and tissue calcification. Death usually results from heart failure.

Although cholecalciferol is effective at killing some species through administration in poisonous bait form, it is not effective in other species. For example, it is not effective in killing members of the mustelid family, such as ferrets, stoats and weasels due the fact that these animals will not eat poisonous baits. Both stoats and ferrets like to explore tunnels and holes in the search for food and prefer warm salty live kills. These animals are among the most destructive pests due to their predation on native fauna such as the kiwi.

Other disadvantages of poisonous baits is the need to have the bait stations very carefully positioned and administered as the baits may be toxic to non-targeted animals such as dogs, cats, stock and humans.

Many countries of the world have problems with animal pests such as rodents, particularly rats and mice, and there is a need for more effective means of controlling and/or eradicating these types of pests.

### Object of Invention

It is an object of the present invention to provide a formulation and method for animal pest control which ameliorates some of the disadvantages and limitations of the known art or which at least provides the public with a useful choice.

### SUMMARY OF INVENTION

In a first aspect the invention relates to a topical pesticide formulation comprising an effective amount of cholecalciferol or a derivative or metabolite thereof and at least one carrier which is capable of delivering the cholecalciferol transdermally to cause the death of an animal pest.

The amount of cholecalciferol present in the formulation typically depends on the species of animal pest to be treated and the size of the animal pest. Examples of animal pests which may be treated with the formulation include mice, rats, stoats, weasels, ferrets, rabbits, hedgehogs and possums.

Preferably, the cholecalciferol is present in an amount of between about 4-50% w/v. More preferably, the cholecalciferol is present in an amount of between about 10-40% w/v.

For example, if the target animal pest species is a rat, stoat or weasel, preferably the formulation contains about 30-40% w/v of cholecalciferol.

The carrier or dermal penetrant may be any carrier that facilitates topical administration and delivery of the cholecalciferol transdermally. Suitable carriers include, for example, absolute alcohol, ethanol, isopropanol, methanol, benzyl alcohol, glycol ethers such as diethylene glycol monomethyl ether, diethylene glycol monoethyl ether and diethylene glycol mono-n-butyl ether, glycerol formal, polyethylene glycols, liquid polyoxyethylene glycols, propylene glycol, pyrrolidones such as N-methylpyrrolidone and 2-pyrrolidone, acetone, acetonitrile, butyl diglycol, dimethyl sulfoxides, dimethylacetamide, dimethylformamide, monomethylacetamide, diethyl phthalate, or any combination thereof

Preferably, the carrier or one of the carriers is absolute alcohol, ethanol, N-methylpyrrolidone, or a glycol ether. More preferably the glycol ether is diethylene glycol monoethyl ether.

Preferably, the formulation is in the form of a foam, gel, or liquid spray.

More preferably, the formulation is contained in a pressurised aerosol can or other container from which it can be automatically dispensed onto the target animal pest.

Silicone may be added to the formulation to assist with adhesion of the formulation to the fur or skin of the animal pest in cases where the fur or skin might be wet.

Calcium may be added to the formulation to improve the efficacy of the formulation.

In a further aspect the invention relates to a method of killing animal pests comprising the steps of preparing or obtaining a formulation as described herein and topically administering said formulation to an animal pest.

Preferably, the formulation is administered to the animal by way of an automatic dispensing apparatus, including a sensing means to detect when the animal is present. The dispensing apparatus may be a pressurised aerosol container, or a container including a pump or spray device for dispensing the formulation, or a pressurised canister containing Nitrogen as a propellant.

Preferably, the formulation is administered in an amount of between about 0.5-3.0 ml per animal.

Dosage rates typically depend on the species of animal pest to be treated and the size of the animal pest.

For example, if the target animal pest species is a stoat, preferably the formulation is topically administered in an amount of about 1.5 ml per animal.

In a further aspect the invention relates to a dispensing apparatus for delivering a topical pesticide formulation to an animal pest, said dispensing apparatus containing a formulation comprising an effective amount of cholecalciferol or a derivative or metabolite thereof and at least one carrier which is capable of delivering the cholecalciferol transdermally to the animal.

Preferably said dispensing apparatus is a pressurised aerosol container. More preferably, said dispensing apparatus is a pressurised canister comprising Nitrogen as a propellant.

Preferably said dispensing apparatus contains at least 250 ml of formulation. Preferably said dispensing apparatus is designed to automatically deliver the formulation to the animal in volumes of at least 0.5 ml per animal.

In a further aspect the invention relates to an apparatus for delivering a topical pesticide formulation to an animal pest, said apparatus comprising means forming at least one partially enclosed space into which the animal can enter or pass through, and at least one automatic dispensing apparatus containing a formulation comprising an effective amount of cholecalciferol or a derivative or metabolite thereof and at least one carrier which is capable of delivering the cholecalciferol transdermally to the animal, said automatic dispensing apparatus being operatively connected to the enclosed space, said enclosed space including at least one sensing means therein to detect when an animal is present in or near the space, wherein said sensing means activates the automatic dispensing apparatus to deliver a predetermined quantity of the cholecalciferol formulation topically to the animal.

Preferably the partially enclosed space resembles a tunnel, hole, burrow, channel or passageway. For example, it could be constructed of one or more pipes of a specific diameter, length or construction.

Preferably the predetermined quantity of cholecalciferol formulation is in the range of about 0.5-3.0 ml.

Preferably, said apparatus may further include a tracking means located within the enclosed space to establish that an animal has passed through the space and received a dose of the formulation. Such tracking means could be a card which identifies and records the footprints of the animals which pass through the space.

These and other features of as well as advantages which characterise the present invention will be apparent upon reading of the following detailed description.

### DETAILED DESCRIPTION

The following description will describe the invention in relation to preferred embodiments of the invention. The invention is in no way limited to these preferred embodiments as they are purely to exemplify the invention only and possible variations and modifications that would be readily apparent without departing from the scope of the invention are intended to be included within the scope of the invention.

The invention relates to a formulation for topical administration to animal pests, wherein the formulation comprises a solution including an effective amount of cholecalciferol (also known as Vitamin D3) or a derivative or metabolite thereof, and at least one dermal penetrant. It is believed that an effective lethal dose of the cholecalciferol can be dermally delivered to an animal pest in solution, thereby being absorbed into the animal's bloodstream and subsequently causing the death of the animal.

As used herein, the term “dermal penetrant” is intended to include all substances or materials which are capable of penetrating the skin into the systemic circulation and/or of moving molecules from the outer surface of the skin into the systemic circulation. The dermal penetrant is typically a liquid solvent which facilitates or enables the transdermal delivery of the cholecalciferol to the animal pest.

The dermal penetrant or solvent used in the formulation should be chosen for its ability to enhance dermal absorption, bioavailability and subsequent toxicity of the cholecalciferol.

Suitable dermal penetrants include, for example, absolute alcohol, ethanol, isopropanol, methanol, benzyl alcohol, glycol ethers such as diethylene glycol monomethyl ether, diethylene glycol monoethyl ether and diethylene glycol mono-n-butyl ether, glycerol formal, polyethylene glycols, liquid polyoxyethylene glycols, propylene glycol, pyrrolidones such as N-methylpyrrolidone and 2-pyrrolidone, acetone, acetonitrile, butyl diglycol, dimethyl sulfoxides, dimethylacetamide, dimethylformamide, monomethylacetamide, diethyl phthalate, or any combination thereof.

As used herein, the term “effective amount” refers to an amount effective to achieve the desired effect, that is, the death of the animal pest.

The amount of cholecalciferol present in the formulation typically depends on the species of animal pest to be treated and the size of the animal pest. The amount of cholecalciferol present is ideally determined by the amount (mg/kg) needed to meet the LD₅₀ of the target species (that is, the lethal dose required to kill 50% of animals). Dermal toxicity (LD₅₀) values will vary depending on the target species. Values often also vary within the species, depending on the sex of the animal.

It is envisaged that silicone may be added to the formulation to assist with adhesion of the formulation to the fur or skin of the animal pest in cases where the fur or skin might be wet.

### PREFERRED EMBODIMENTS

Cholecalciferol is commercially available in two forms, that is, as a white powder and a solid resin block. Formulations of the present invention have been prepared using both the powder and resin forms of cholecalciferol.

The following table sets out some example formulations that have been successfully prepared and tested to date:

| | Cholecalciferol | Cholecalciferol | |
|---|---|---|---|
| Example | type | concentration (%) | Solvent |
| 1 | Resin | 4 | Absolute alcohol |
| 2 | Resin | 20 | Absolute alcohol |
| 3 | Resin | 40 | Absolute alcohol |
| 4 | Resin | 12.4 | Ethanol |
| 5 | Resin | 24.8 | Ethanol |
| 6 | Powder | 25 | Ethanol |
| 7 | Powder | 35 | Ethanol |
| 8 | Powder | 35 | N-methylpyrrolidone (NMP) |
| 9 | Resin | 32 | Diethylene glycol monoethyl |
| | | | ether (DGMEE) |
| 10 | Resin | 33 | Diethylene glycol monoethyl |
| | | | ether (DGMEE) |

In order to prepare the formulations using cholecalciferol in resin block form, the resin block is heated until it melts (usually at a temperature of between 50-90° C.). It is then dissolved in oil and remains in solution as it cools. A solution of the required amount of cholecalciferol and the dermal penetrant(s) is then prepared. In order to prepare the formulations using cholecalciferol in powder form, the powder is made into solution with the dermal penetrant(s). The amount of cholecalciferol included in the formulation will vary depending on the target pest species and the size of the pest species.

Preferably, the cholecalciferol is present in an amount of between about 4-50% w/v. More preferably, the cholecalciferol is present in an amount of between about 10-40% w/v.

It is envisaged that calcium may be added to the formulation to improve the efficacy of the formulation.

The formulation is designed to be topically administered to the animal pest. The formulation is therefore preferably a liquid or paste, and may be for example a foam, gel or liquid spray.

Preferably the formulation is applied to the animal by way of an eradication apparatus as described by one of the present inventors in New Zealand Patent No. 540012, which is hereby incorporated by reference. The eradication apparatus includes a tunnel and an automatic dispensing apparatus in the form of a spray means such as a pressurised aerosol container containing the toxic formulation. The automatic dispensing apparatus is operatively connected to the tunnel, together with at least one sensing means so that when an animal passes through the tunnel, the sensors detect the presence of the animal and sense the body length or size of the animal and activate the spray means to deliver a pre-determined amount of the formulation to the fur or skin surface of the target animal, which will be absorbed into the animal's system and cause its death. Such an eradication apparatus is advantageous for killing pests such as mustelids, as all mustelids run through tunnels due to their natural curiosity, so no lure is required. It is envisaged that the eradication apparatus could be modified depending on the type of animal pest to be targeted. For example, instead of tunnels, sections of large diameter (200-300 mm) pipes could be used fitted. with the sensor activated pump or spray units to apply the toxic formulation. The target species may use such pipes for shelter, hiding or resting. The apparatus could comprise any suitable means which form at least one partially enclosed space into which the animal can enter or pass through.

Preferably the automatic dispensing apparatus is a pressurized container such as a canister, containing Nitrogen as the propellant, and the system is designed so that there is no dilution factor due to the propellant exiting the system in mixture with the formulation contained therein, as is the case in standard aerosol systems. The use of this type of propellant and canister means that the same discharge pressure is maintained from the first discharge of the formulation contained therein to the last. Other spray means in the form of pump devices or the like may be used. For example, pumps may be more effective at delivering the formulation in cold climates where there is not enough pressure to deliver the formulation from a pressurised aerosol container. Preferably, the canister contains enough formulation to deliver about 250 shots each of about 1 ml in volume; however the dispensing device could obviously be modified to deliver any number of shots of any desired volume. The automatic dispensing apparatus could also be modified to deliver the formulation at more than one location within the tunnel or space which the animal pest enters or passes through, for example, it could be adapted to deliver formulation from locations at the bottom, top and/or sides or any combination thereof of the tunnel or other space. Preferably the dispensing apparatus or spray means comprises an electronic controller such as a microchip which activates the dispensing apparatus to deliver the predetermined amount of the formulation upon receipt of information from the sensing means that an animal is present.

Preferably, the formulation is administered in an amount of between about 0.5-3.0 ml per animal, however dosage rates will vary depending on the species of animal pest and the size of the animal pest.

Small animals move very fast so it may only be possible to topically apply 0.5 ml of the formulation via the eradication apparatus if the animal runs through the apparatus quickly, in which case a higher concentration formulation could be applied to ensure that an effective amount of the toxic substance is delivered to the animal's bloodstream.

A formulation of the present invention was initially prepared and tested on mice and laboratory rats to determine the viability of the invention. The formulation contained cholecalciferol in an amount of 4% w/v and absolute alcohol. The formulation was applied to the mice and laboratory rats in an amount of 0.5 ml per animal, and in each case death of the animal occurred within a reasonably short time frame. Given these results, further studies were carried out to test the efficacy of the formulations of the invention. These studies are described in the following examples.

### EXAMPLE 1

Two formulations of the invention were prepared both containing cholecalciferol in solution with absolute alcohol. One of the formulations contained cholecalciferol in an amount of 20% w/v. The other formulation contained cholecalciferol in an amount of 40% w/v. The formulation was topically applied to several animal pest species in varying amounts and the animals were studied. The results of the study are set out in Table 1 below.

TABLE 1
Results of dermal application of cholecalciferol in various
animal pest species.

| | | | Amount of | % cholecal- | |
|---|---|---|---|---|---|
| | Weight of | | formulation | ciferol | |
| Animal Species | Animal | | applied | in solution | Observations |
| Lab Rat (Rattus | Unknown | | 0.5 ml | 20% | Death occurred |
| norvegicus) | | | | | within 72 hours |
| Bush Rat | Unknown | | 1.0 ml | 20% | Death occurred |
| (Rattus rattus) | | | | | within 40 hours |
| Rabbit | 2.6 | kg | 2.0 ml | 20% | Death occurred |
| | | | | | within 2 days |
| Hedgehog | 515 | g | 1.5 ml | 20% | Death occurred |
| | | | | | within 25 hours |
| Weasel | 139 | g | 1.5 ml | 40% | Death occurred |
| | | | | | within 36 hours |
| Weasel | 116 | g | 1.5 ml | 40% | Death occurred |
| | | | | | within 43 hours |
| Ferret | 902 | g | 2.0 ml | 40% | Death occurred |

within 48 hours

It was observed that death appeared to occur without causing pain to the animal.

### EXAMPLE 2

### Methodology

A test solution of approximately 100 ml was formulated, containing Vitamin D3 (cholecalciferol) resin in the solvent absolute alcohol. The concentration of cholecalciferol in the solution was about 40% w/v. The formulation was designed to kill stoats.

To confirm the cholecalciferol concentration present and enable accurate exposure calculations when the test solution was applied to the stoats, a sub-sample (approximately 20 ml) of this solution was taken for analysis. Cholecalciferol concentration was determined by taking a sample of liquid which was warmed, mixed and 0.2 g weighed into a volumetric flask 30 ml of toluene was added, and this solution was sonicated without heating and made up to volume. The solution was diluted with hexane/isopropyl alcohol, filtered and analysed against an internal standard by normal phase liquid chromatography.

Wild-caught adult stoats (three male and three female) were housed in outdoor cages (60×150×90 cm). Each stoat was provided with a nest box (40×33×15 cm) containing shredded paper as nesting material. Stoats were fed a rotation of, dead day-old chicks, chicken pet mince and mutton/beef pet mince in the afternoon and had free access to water.

They were acclimatised to captivity for at least 5 months prior to being used in the trial. The stoats were lightly anaesthetised with isoflurane, weighed and then had 1.5 ml of the test solution applied to their skin and fur, using a syringe to deliver a line of solution along the spine from the nape to the base of the tail. This was a ‘high exposure’ simulation of the manner in which the delivery system would apply a toxic solution to the fur and skin of stoats.

After application of the solution, the stoats were placed into large nest boxes which were lined with paper but without bedding material, to facilitate observation. Dark Perspex lids were kept on the nest boxes to minimise disturbance of stoats by human observers. The stoats were monitored constantly through recovery from anaesthesia and then for the next three hours to record their responses to the solution on their coats and document any behaviour associated with its presence e.g. grooming, rubbing or rolling. After the three hour observation period in the boxes, stoats were returned to their outdoor cages with nesting material, food and water freely available. They were observed at least hourly for the remainder of that day for any signs of poisoning or responses to the solution. After this, observations of each stoat were recorded once daily, noting any signs of illness that are associated with cholecalciferol poisoning, e.g. stop feeding, significant body weight loss. Where any signs of illness occurred, the monitoring was to be increased to twice daily (morning and afternoon).

Feed intakes of the stoats were visually estimated for at least three days prior to dosing, i.e. ration all eaten, half eaten, quarter eaten, none eaten. Food intake was similarly noted daily after dosing through until death or 21 days (whichever occurred first). Stoats were weighed at least once a week after dosing, through to death or 21 days (which ever occurred first). Any stoats that died during the 21 day observation were to be retained for necropsy. Typical signs of poisoning (inappetance combined with significant body weight loss) were used as an alternative endpoint for the trial, with a weight loss greater than 25% of bodyweight at dosing triggering euthanasia. Stoats that survived the 21 day observation were to be euthanized.

### Results

The test solution was analysed as containing 30% cholecalciferol with an uncertainty of 5%. This was lower than the nominal 40% cholecalciferol in the solution indicated by the analysis carried out the day after the solution was prepared. The assay was carried out on a sub-sample of solution taken 7 days after preparation, and also following the extraction of 6×1.5 ml aliquots of the solution for application to stoats.

During recovery from anaesthesia, 5 of the 6 stoats tried to shake the solution from their backs but otherwise showed normal behaviours and movements for the next three hours. None were observed trying to groom or rub the solution off, one was observed scratching the treated area with a hind foot. The morning after the stoats were returned to the outdoor cages, vomitus was present in three of the 6 cages (female 413, male 391 and male 415). All six stoats showed inappetance from the first night after dosing, generally eating less than half of rations each day. This ‘stop feed’ effect was considered a typical sign of cholecalciferol poisoning, which was reflected in mortality in three stoats and large losses in bodyweight of the remaining stoats over the following 12 days (see Table 2).

Using the 30% cholecalciferol concentration assayed as a conservative estimate, 1.5 ml of the solution contained 450 mg of cholecalciferol. Table 2 shows the estimated dermal exposures of cholecalciferol delivered to each the six stoats, according to their bodyweight at dosing. The three female stoats died at 4, 11 and 12 days after dosing respectively. The remaining three males were euthanized 12 days after dosing, having triggering the weight loss endpoint—it is highly likely these stoats would have died within the 21 day observation period planned. Necropsy of the stoats that died revealed no gross evidence of calcification/mineralisation or lung damage that has been associated with cholecalciferol poisoning in brush tail possums. At death, the site of the solution application was evident from extensive matting of fur.

TABLE 2
Estimated dermal exposure of cholecalciferol in six stoats, fate and changes
in bodyweight over the 12 days after dosing.

| | Estimated | | | | | % weight |
|---|---|---|---|---|---|---|
| | cholecalciferol | Fate (days after | Weight at | Weight at | Weight at | loss at |
| Stoat ID | exposure (mg/kg) | dosing) | dosing (g) | day 7 (g) | day 12 (g) | death |
| Male 415 | 1178 | euthanized (12) | 382 | 296 | 254 | 36 |
| Male 419 | 1253 | euthanized (12) | 359 | 277 | 253 | 37 |
| Male 391 | 1914 | euthanized (12) | 235 | 188 | 166 | 30 |
| Female 414 | 2205 | died (4) | 204 | na | Na | 13 |
| Female 407 | 2331 | died (12) | 193 | 151 | 112 | 46 |
| Female 413 | 2486 | died (11) | 181 | 120 | Na | 44 |

The estimated dermal exposure delivered to the stoats ranged from 1178-2486 mg/kg, with variability largely due to the differences in starting bodyweights between males and females, the latter receiving relatively higher exposures due to their smaller size. The higher cholecalciferol exposures received by female stoats, and their subsequent mortality from poisoning within 12 days (in contrast to euthanasia at the weight loss endpoint in all three males) is suggestive of a dose-dependent time to death. However, all stoats displayed similar timing in onset of signs of poisoning (inappetance) and a similar progression of weight loss. The male stoats that were euthanized were highly likely to have eventually died of poisoning, so the lower end of exposure range probably represents an effective lethal dermal exposure for stoats to this solution (i.e. in excess of or equal to a dermal LD₉₉ value).

The results of this trial suggest that an effective lethal, dose of cholecalciferol can be dermally delivered to stoats in the test solution.

It has since been found that the formulations are more effective when delivered in a concentrated amount to a single small area of an animal, rather than a large area. For example, it is preferable for the formulation to be delivered in a circle or spot on the back of the animal, rather than as a strip or line along the back of the animal. The spot may be about 2 cm in size for example. Accordingly, the automatic dispensing device should be designed where possible to deliver the formulation in this manner. This can be accomplished by narrowing the spray means of the sensor activated dispensing apparatus, for example by passing it through a fine 1 mm diameter pipe, resulting in the release of the toxin to a restricted area of the target species.

The solvent or dermal penetrant used in the formulation should be chosen for its ability to enhance dermal absorption, bioavailability and subsequent toxicity of cholecalciferol. If lower dermal exposures are found to be lethal to stoats, this would entail considerably smaller delivery volumes than the 1.5 ml used in this trial and less cholecalciferol, which would reduce unit costs.

### Stability of Formulation

Within the stated analysis uncertainty of ±5%, it is likely there was a slight decline of the cholecalciferol concentration in the test solution during the 7 days from preparation to application. This may mostly have occurred on exposure to air when aliquots of solution were drawn from the container for application to the stoats. Cholecalciferol preparations are sensitive to light and exposure to air, with oxidation and inactivation occurring over a few days in the presence of moist air. However, it is noted that even at a 30% concentration, the solution contained sufficient cholecalciferol to deliver an effective lethal dose to all six stoats in 1.5 ml.

### EXAMPLE 3

Three wild weasels were caught for a proof of concept trial to determine if the formulation of the invention would be effective as a humane method of killing these pests. The weasels were caged separately in individual waterproof, roofed, wired enclosures of approximately 1 m². The animals were fed on raw meat, by simply placing the meat on a wire hooked into the side of the cages. In eating the animals simply pulled on and chewed the meat. Drinking water was available. Within each enclosure was a small box of 25×25 cm with a mesh roof. A vertical sliding door could be removed to provide an entrance to the enclosure and the enclosure was half filled with nesting material of hay. It was observed that the animals covered themselves in the hay and made pathways through it.

Each of the animals was then treated with a formulation comprising 32% cholecalciferol (resin form) in solution with the glycol ether, DGMEE, and observations were made.

The first animal, a male weasel weighing 157 grams, was treated by application of 1 ml of the formulation using a syringe to the back of the animal. This weasel died within 44 hours of application of the formulation. The animal did not appear to be in any discomfort following the application. It was observed that it ate only a small quantity of what it had previously been consuming.

The second animal, a female weasel weighing 94 grams, was treated using an eradication apparatus as described above. The electronically activated apparatus was placed into the cage of the animal. The apparatus comprised of a tunnel, including a sensing means comprising two pairs of sensors, and a tracking card to record the footprints of the weasel to establish that the animal had passed through the tunnel. An automatic dispensing means was operatively connected to the tunnel, so that when the weasel passed through the tunnel and the two pairs of sensors were covered ,simultaneously, the dispensing , means was automatically activated to deliver the formulation to the animal. In this manner, approximately 0.9 ml of the cholecalciferol formulation was applied to the back of the weasel as it passed through the tunnel of the apparatus. It was observed that some of the formulation was present on the tracking card so the weasel had not received the total volume of the formulation. The weasel died approximately 50 hours after receiving the formulation. It was observed that the animal lost its appetite after receiving the formulation, but otherwise showed no other signs of discomfort.

The third animal, a male weasel weighing 54 grams was treated by squirting approximately 1 ml of the formulation onto the back of the animal using a hand held syringe. This weasel died within about 39 hours of application of the formulation. It did not appear to show any signs of discomfort prior to death.

### EXAMPLE 4

Three animals of the species Rattus rattus (also known as the bush rat) were live captured. They were placed in separate enclosures with on demand food and water supplies, and nesting material of dry hay. After 14 days of acclimatization to these conditions, the animals were each treated with a formulation comprising a solution of 33% cholecalciferol (resin form) in the glycol ether, DGMEE. Each animal was given a dose of about 3 ml of the formulation by topical administration to the back of the animal using a calibrated syringe. Each of the animals died within six days of receiving the formulation. The first rat, a male weighing 122 grams, weighed 106 grams at death. The second rat, a female weighing 108 grams, weighed 98 grams at death. The third rat, a male weighing 97 grams, weighed 90 grams at death. Over the first few days of receiving treatment hair loss was observed on all of the animals at the location at which the formulation was applied. However, the animals showed no signs of discomfort, and ate, drank and behaved as normal until they died suddenly on day six. These results show that topical application of a cholecalciferol formulation kills a lot quicker and more humanely than use of traditional poisons in bait form.

### EXAMPLE 5

Approximately 3 ml of a formulation comprising a solution of 32% cholecalciferol (resin form) in the glycol ether, DGMEE, was applied to the back of a possum. The possum died approximately 5 days or 120 hours after application of the formulation. It did not appear to show any signs of discomfort or distress prior to its death.

### Advantages

a) The formulation can be administered in lethal doses to the targeted animal pest without having to rely on the targeted pest consuming or continuing to consume an edible poison or bait.
b) Reduces the need of dispersing poisoned bait within the environment, and the need for inefficient old style clamping traps.
c) Advantages of administering the formulations by way of spray apparatus attached to tunnels or pipes means there is low risk to non-target animals such as dogs, cats, stock and humans as they cannot access the tunnels or nines.
d) Cost effective as only a very small amount of formulation is needed per animal.

e) By using cholecalciferol as the toxic substance, there is reduced risk of secondary poisoning to predators and scavengers, as well as low environmental persistence and low toxicity to bird life and humans.

### Variations

Although the trials and examples described herein are directed to use on rats and mice, stoats, ferrets, weasels, rabbits, hedgehogs and possums, it will be appreciated by those skilled in the art that the teachings of the present invention can be applied to other mammals, vertebrates, reptiles, and amphibians that are considered pests. For example, the formulations of the present invention may be applied to cane toads, brown tree snakes, other snakes, frogs, mongoose, foxes and other animal pests.

It will of course be realised that while the foregoing has been given by way of illustrative example of this invention, all such and other modifications and variations thereto as would be apparent to persons skilled in the art are deemed to fall within the broad scope and ambit of this invention as is hereinbefore described.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein; this reference does not constitute an admission that any of these documents form part of the common general knowledge in the art, in New Zealand or in any other country.

1. A topical pesticide formulation comprising an effective amount of cholecalciferol or a derivative or metabolite thereof and at least one carrier which is capable of delivering the cholecalciferol transdermally to cause the death of an animal pest.

2. A formulation as claimed in claim 1, wherein the cholecalciferol or derivative or metabolite thereof is present in an amount of between about 4-50% w/v.

3. A formulation as claimed in claim 2, wherein the cholecalciferol or derivative or metabolite thereof is present in an amount of between about 10-40% w/v.

4. A formulation as claimed in claim 1 wherein the carrier or each carrier is selected from the group comprising absolute alcohol, ethanol, isopropanol, methanol, benzyl alcohol, glycol ethers, glycerol formal, polyethylene glycols, liquid polyoxyethylene glycols, propylene glycol, pyrrolidones such as N-methylpyrrolidone and 2-pyrrolidone, acetone, acetonitrile, butyl diglycol, dimethyl, sulfoxides, dimethylacetamide, dimethylformamamide, monomethylacetamide, diethyl phthalate, or any combination thereof.

5. A formulation as claimed in claim 4, wherein the carrier or one of the carriers is absolute alcohol, ethanol, N-methylpyrrolidone, or a glycol ether.

6. A formulation as claimed in claim 5, wherein the glycol ether is diethylene glycol monoethyl ether.

7. A formulation as claimed in claim 1, wherein the formulation further includes calcium.

8. A method of killing a non-human animal pest comprising the steps of:
a. preparing or obtaining a formulation as claimed in claim 1; and
b. topically administering the formulation to the animal pest.

9. A method as claimed in claim 8, wherein the formulation is topically administered to the animal by way of an automatic dispensing apparatus including at least one sensing means to detect when the animal is present.

10. A method as claimed in claim 8, wherein the formulation is administered to the animal in an amount of between about 0.5-3.0 ml.

11. A method as claimed in claim 8, wherein the animal pest is a mouse, rat, stoat, weasel, ferret, rabbit, hedgehog or possum.

12. An apparatus for delivering a topical pesticide formulation to an animal pest, said apparatus comprising means forming at least one partially enclosed space into which the animal can enter or pass through, and at least one automatic dispensing apparatus containing a formulation comprising an effective amount of cholecalciferol or a derivative or metabolite thereof and at least one carrier which is capable of delivering the cholecalciferol transdermally to the animal, said automatic dispensing apparatus being operatively connected to the enclosed space, said enclosed space including at least one sensing means therein to detect when an animal is present in or near the space, wherein said sensing means activates the automatic dispensing apparatus to deliver a predetermined quantity of the cholecalciferol formulation topically to the animal.

13. A formulation as claimed in claim 2 wherein the carrier or each carrier is selected from the group comprising absolute alcohol, ethanol, isopropanol, methanol, benzyl alcohol, glycol ethers, glycerol formal, polyethylene glycols, liquid polyoxyethylene glycols, propylene glycol, pyrrolidones such as N-methylpyrrolidone and 2-pyrrolidone, acetone, acetonitrile, butyl diglycol, dimethyl, sulfoxides, dimethylacetamide, dimethylformamamide, monomethylacetamide, diethyl phthalate, or any combination thereof.

14. A formulation as claimed in claim 3 wherein the carrier or each carrier is selected from the group comprising absolute alcohol, ethanol, isopropanol, methanol, benzyl alcohol, glycol ethers, glycerol formal, polyethylene glycols, liquid polyoxyethylene glycols, propylene glycol, pyrrolidones such as N-methylpyrrolidone and 2-pyrrolidone, acetone, acetonitrile, butyl diglycol, dimethyl, sulfoxides, dimethylacetamide, dimethylformamamide, monomethylacetamide, diethyl phthalate, or any combination thereof.

15. A formulation as claimed in claim 2, wherein the formulation further includes calcium.

16. A formulation as claimed in claim 3, wherein the formulation further includes calcium.

17. A formulation as claimed in claim 4, wherein the formulation further includes calcium.

18. A formulation as claimed in claim 5, wherein the formulation further includes calcium.

19. A formulation as claimed in claim 6, wherein the formulation further includes calcium.

20. A method as claimed in claim 9, wherein the formulation is administered to the animal in an amount of between about 0.5-3.0 ml.
